(19) United States
(12) Patent Application Publication
(10) Pub. No.: US 2024/0396265 A1
(43) Pub. Date: Nov. 28, 2024

(54) CONNECTOR SYSTEM WITH CONNECTOR POSITION ASSURANCE ELEMENT

(71) Applicant: Aptiv Technologies AG, Schaffhausen (CH)

(72) Inventors: Laurent MORIN, Rambouillet (FR); Frederic MENEZ, Hermeray (FR); Stephane LACOTE, Chartres (FR)

(21) Appl. No.: 18/672,527

(22) Filed: May 23, 2024

(30) Foreign Application Priority Data
May 26, 2023 (EP) 23175690.9

(51) Int. Cl. H01R 13/641; H01R 13/627

(52) U.S. Cl. CPC H01R 13/641; H01R 13/6271

(57) ABSTRACT

The present disclosure refers to a connector system and particularly an electrical connector system. The connector system includes a first connector housing having a first locking feature. Further, the connector system includes a second connector housing being configured to mate with the first connector housing and having a second locking feature. The first and second locking feature are configured to directly or indirectly lock the first connector housing and the second connector housing with each other. Moreover, the connector system includes a connector position assurance (CPA) element being configured to tension the first locking feature and the second locking feature relative to each other when the CPA element is assembled with the mated connector housings.

### CROSS-REFERENCE TO RELATED APPLICATION

This application claims the benefit of and priority to European Patent Application No. 23175690.9 titled “Connector System with CPA Element” filed on May 26, 2023, the contents of which are incorporated by reference herein.

### TECHNICAL FIELD

The present disclosure relates to a connector system and in particular an electrical connector system.

### BACKGROUND

Connector systems, particularly electrical connector systems, with high safety and reliability requirements are increasingly utilized in various industries and especially the automotive industry due to the advancing vehicle electrification. One of the reasons for this is that highly safety-relevant vehicle functions, such as the powertrain and the braking system, are increasingly being operated and controlled electrically.

With regard to the safety and the reliability of connector systems, especially electrical connector systems, it is of great importance that vibrations, shocks, but also other mechanical loads do not lead to malfunctions or even failures. In this regard prior art connector systems regularly exhibit drawbacks which are set out in the following at the example of a prior art connector system 100 that is illustrated in FIG. 7.

The connector system 100 of FIG. 7 includes a first connector housing 1000 having a first locking feature 1100. Further, the connector system 100 includes a second connector housing 2000 configured to mate with the first connector housing 1000 and having a second locking feature 2100. As depicted, the first connector housing 1000 is mated with the second connector housing 2000. The first and second locking feature 1100, 2100 directly locks the first connector housing 1000 and the second connector housing 2000 with each other. It is understood that the first connector housing 1000 and the second connector housing 2000 e may each have an electrical conductor.

However, as can be seen in FIG. 7, even though they are locked with each other, free spaces exist between the first connector housing 1000 and the second connector housing 2000, for example due to manufacturing tolerances. These free spaces allow relative movement between the two connector housings in the event of vibrations and other mechanical loads. This can lead to wear and subsequent damage to components of the connector system. In addition, malfunctions such as temporary or permanent interruptions of the electrical signal can occur.

Thus, it is an object of the present disclosure to provide a connector system that at least partially overcomes the aforementioned drawbacks and that particularly allows for an increased level of safety and/or reliability.

### SUMMARY

An electrical connector system includes a first connector housing having a first locking feature; a second connector housing being configured to mate with the first connector housing and having a second locking feature, wherein the first and second locking feature are configured to directly or indirectly lock the first connector housing and the second connector housing with each other, and a connector position assurance (CPA) element being configured to tension the first locking feature and the second locking feature relative to each other when the CPA element is assembled with the mated connector housings.

The first connector housing and the second connector housing may, for example, be configured to be mated by inserting the second connector housing into a receptacle formed inside the first connector housing or vice versa.

The first locking feature may be integrally formed with the first connector housing. Further, the second locking feature may be integrally formed with the second connector housing. Particular examples of configurations of the first and second locking feature are provided throughout the present disclosure.

When the first and second locking feature are configured to directly lock the first connector housing and the second connector housing with each other, no intermediate element may be required to lock the first connector housing and the second connector housing with each other. Accordingly, when the first and second locking feature are configured to indirectly lock the first connector housing and the second connector housing with each other, an intermediate element, such as the CPA element, may be required to lock the first connector housing and the second connector housing with each other. Advantages referring to a direct locking and an indirect locking are provided throughout the following.

The CPA element ensures that the connector housings are completely, securely and/or accurately connected to each other. Preferably, it is configured to indicate, e.g., visually, that a proper engagement of the connector housings is achieved. Thereby accidental disconnection, incomplete connection, and/or damage may be avoided. Examples for particular configurations of CPA elements are provided throughout the present disclosure.

Moreover, by the CPA element being configured to tension the first locking feature and the second locking feature relative to each other, it allows to compensate free spaces, e.g., due to tolerances, between the first connector housing and the second connector housing. Hence, the CPA element serves to avoid relative movements between the two connector housings. Thereby wear and subsequent damage to components of the connector system and/or malfunctions such as brief and/or permanent interruptions of the electrical signal may be avoided or at least reduced. For example, the CPA element may be configured to press the first locking feature against the second locking feature. Alternatively, the CPA element may be configured to press the first locking feature away from the second locking feature. Further details in this regard are also set out through the following.

Furthermore, as set out above it is to be noted that within the connector system, the CPA element allows to combine the first functionality to ensure that the connector housings are completely, securely and/or accurately connected to each other and the second functionality to avoid relative movements between the two connector housings. Thus, connectors systems which require less parts and/or less space and at the same time allow for improved safety and/or reliability may be achieved.

The CPA element may have a tapered shape, wherein preferably the CPA element has a wedge shape. By the CPA element having a tapered shape a tensioning of the first locking feature and the second locking feature relative to each other can be achieved, when the CPA element is inserted into, i.e., assembled with, the mated connector housings. A wedge shape is preferred as the tensioning of the first locking feature and the second locking feature relative to each other can be achieved in a particularly continuous manner.

The first connector housing and/or the second connector housing may include an actuation surface being arranged to slidingly guide the CPA element into the assembled position when the connector housings are mated, wherein the actuation surface is inclined relative to the direction along which the CPA element is insertable into the first connector housing and/or the second connector housing. By said actuation surface a tensioning of the first locking feature and the second locking feature relative to each other can be achieved when the CPA element is inserted into, i.e., assembled with, the mated connector housings. Particularly, by the actuation surface being inclined relative to the direction along which the CPA element is insertable into the first connector housing and/or the second connector housing the first and second locking feature can be pressed against or away from each other when the CPA element is inserted.

It is understood that the CPA element may have a tapered shape and at the same time the first connector housing and/or the second connector housing may include said actuation surface.

The first connector housing, the second connector housing, and/or the CPA element may substantially consist of a polymer material. Thereby a simplified manufacturing may be achieved, for example, by highly efficient manufacturing processes such as injection molding.

The connector system may be configured such that the CPA element can be assembled with the first and the second connector housing only when they are mated with each other. For example, the connector system may be adapted such that an insertion of the CPA element is only possible when the connector housings are correctly aligned and completely mated with each other. By the connector system being configured such that the CPA element can be assembled with the first and the second connector housing only when they are mated with each other it can be ensured that the connector housings are completely, securely and/or accurately connected to each other. Hence, accidental disconnection and/or incomplete connection may be avoided.

Preferably, the first locking feature includes a locking receiving area and the second locking feature includes a resilient arm with a locking portion shaped to form-fittingly engage with the locking receiving area. The locking receiving area may be a recess formed into the first connector housing. Alternatively, the locking receiving area may be located at least partially on a protrusion being formed on the first connector housing. The first and second locking feature are preferably configured to directly lock the first connector housing and the second connector housing with each other. Hence, the level of safety and/or reliability can be further increased. This is as a primary locking can be already achieved by an engagement of the first and the second locking feature.

The CPA element may be adapted to press the locking portion into the locking receiving area when the CPA element is assembled with the mated connector housings. Thereby free spaces, e.g., due to tolerances, between the first connector housing and the second connector housing may be compensated. Thus, the CPA element serves to avoid relative movements between the two connector housings. Accordingly, wear and subsequent damage to components of the connector system and/or malfunctions such as brief and/or permanent interruptions of the electrical signal may be avoided or at least reduced.

The locking receiving area may include a ramp surface being arranged such that the locking portion is urged into a clearance-free position when the CPA element presses the locking portion towards the locking receiving area. It has shown that thereby a connection can be achieved which is particularly resistant against vibrations.

For example, the locking receiving area may have a tapered shape, wherein preferably the locking receiving area tapers in the direction along which the locking portion is engageable with the locking receiving area. In other words, the locking receiving area may narrow in the direction along which the locking portion is engageable with the locking receiving area. Thus, a self-alignment of the locking portion can take place when it is moved into the locking receiving area. Accordingly, a particularly reliable coupling operation may be achieved.

The locking receiving area may be arranged on an outer circumferential surface of the first connector housing. According to the present disclosure an outer circumferential surface may be defined as a circumferential surface which faces outwards. Accordingly, an inner circumferential surface may be defined as a circumferential surface which faces inwards. By the locking receiving area being arranged on an outer circumferential surface of the first connector housing the ability to inspect it may be enhanced.

Preferably the first locking feature includes a first abutment portion adapted to abut the CPA element and the second locking feature includes a second abutment portion to abut the CPA element, wherein the CPA element is adapted to press the first abutment portion and the second abutment portion away from each other when being assembled with the mated connector housings. In this configuration the first and second locking feature are preferably configured to indirectly lock the first connector housing and the second connector housing with each other. Thereby the simplicity of the connector system can be particularly increased. This is as the CPA element combines the first functionality to ensure that the connector housings are completely, securely and/or accurately connected to each other and the second functionality to avoid relative movements between the two connector housings. Thus, a connector system which requires less parts and/or less space and at the same time allows for improved safety and/or reliability can be achieved. The first abutment portion may be integrally formed with the first connector housing. Further, the second abutment portion may be integrally formed with the second connector housing.

As an example, the CPA element may be insertable between the first abutment portion and the second abutment portion along a direction which substantially extends perpendicular to the mating direction of the first and second connector housings. It is understood that the first and second abutment portions may be moved past each other when mating the connector housings. Accordingly, subsequent insertion of the CPA element causes the connector housings to move further together. It has been shown that this configuration allows for particularly reliable connections. It is assumed by the inventors that one reason for this may be that the CPA element is arranged transverse to the mating direction of the connector housings.

The first abutment portion may include a first protrusion and/or the second abutment portion may include a second protrusion. Such protrusions may be simply provided by established manufacturing processes such as injection molding. It is understood that each abutment portion may also include more than one protrusion. Nevertheless, it is also understood that the first and/or the second abutment portion may be formed by a through hole being provided in the respective connector housing, e.g., by a through hole which serves to insert the CPA element into the first and/or the second connector housing.

The first abutment portion may be arranged on an outer circumferential surface of the first connector housing and/or the second abutment portion may be arranged on an inner circumferential surface of the second connector housing. Accordingly, the first and second abutment portions may be moved past each other when mating the connector housings.

Preferably, the connector system includes a first electrical contacting feature arranged within the first connector housing and a second electrical contacting feature arranged within the second connector housing, wherein the first and second electrical contacting feature are adapted to establish electrical contact when the first connector housing is mated with the second connector housing. Accordingly, the connector system may be referred to as an electrical connector system.

### BRIEF DESCRIPTION OF THE DRAWINGS

The present invention is now described, by way of example with reference to the accompanying drawings, in which:

FIG. 1 shows a cross-section view of a connector system in a disassembled state according to some embodiments.

FIG. 2 shows a cross-section view of the connector system with the connector housings being mated but without the CPA element being inserted according to some embodiments.

FIG. 3 shows a cross-section view of the connector system with the connector housings being mated and with the CPA element being inserted according to some embodiments.

FIG. 4 shows a cross-section view of a connector system in a disassembled state according to some embodiments.

FIG. 5 shows a cross-section view of the connector system in a partly assembled state according to some embodiments.

FIG. 6 shows a cross-section view of the connector system with the connector housings being mated and with the CPA element being inserted according to some embodiments.

FIG. 7 shows a cross-section view of a connector system according to the prior art.

### DETAILED DESCRIPTION

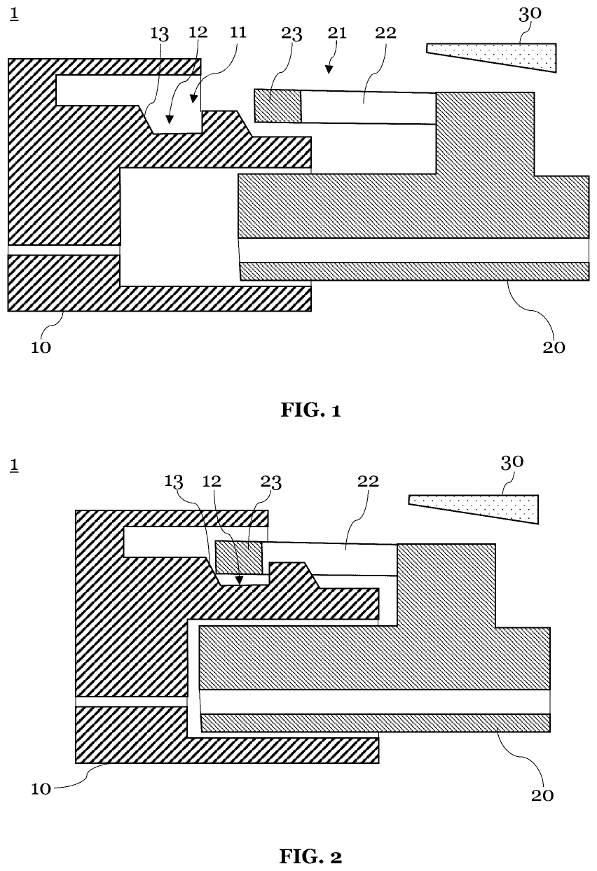

FIG. 1, FIG. 2, and FIG. 3 show a connector system 1 according to a first example. The connector system 1 includes a first connector housing 10 having a first locking feature 11. Further, the connector system 1 includes a second connector housing 20 being configured to mate with the first connector housing 10 and having a second locking feature 21. As particularly depicted in FIG. 2, the first and second locking feature 11, 21 are configured to directly lock the first connector housing 10 and the second connector housing 20 with each other. Moreover, the connector system 1 includes a connector position assurance (CPA) element 30 being configured to tension the first locking feature 11 and the second locking feature 21 relative to each other when the CPA element 30 is assembled with the mated connector housings 10, 20. The CPA element 30 has a tapered wedge shape. It is understood from FIG. 2 and FIG. 3 that the connector system 1 is configured such that the CPA element 30 can be assembled with the first and the second connector housing 10, 20 only when they are mated with each other.

Further, as also depicted in FIG. 1, FIG. 2, and FIG. 3, the first locking feature 11 includes a locking receiving area 12 and the second locking feature 21 includes a resilient arm 22 with a locking portion 23 shaped to form-fittingly engage with the locking receiving area 12. As particularly depicted in FIG. 3, the CPA element 30 is adapted to press the locking portion 23 into the locking receiving area 12 when the CPA element 30 is assembled with the mated connector housings 10, 20. Moreover, the locking receiving area 12 includes a ramp surface 13 being arranged such that the locking portion 23 is urged into a clearance-free position when the CPA element 30 presses the locking portion 23 towards the locking receiving area 12. Particularly, the locking receiving area 12 has a tapered shape and tapers in the direction along which the locking portion 23 is engageable with the locking receiving area 12. Further particularly, the locking receiving area 12 includes a recess formed into the first connector housing 10. The locking receiving area 12 is arranged on an outer circumferential surface of the first connector housing 10.

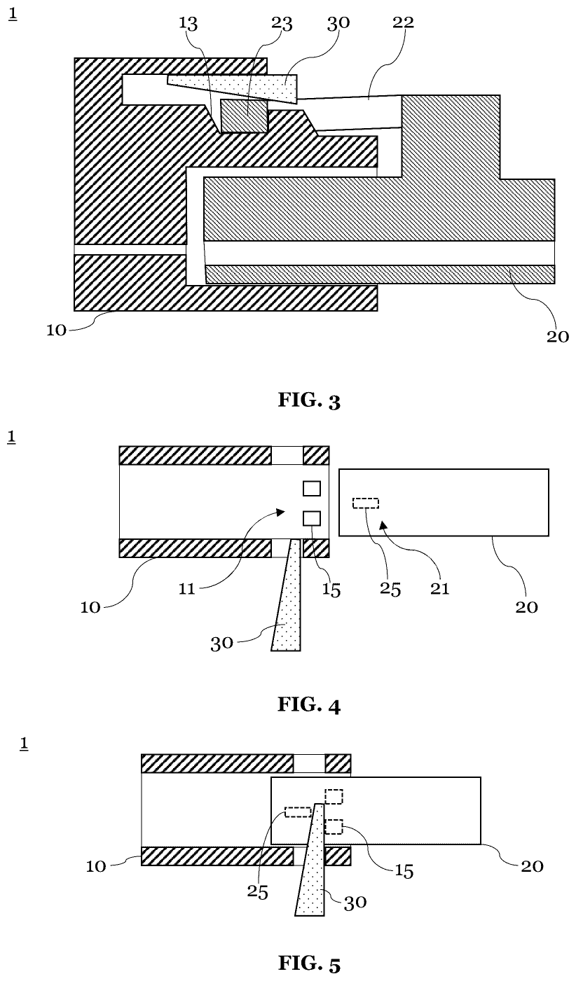

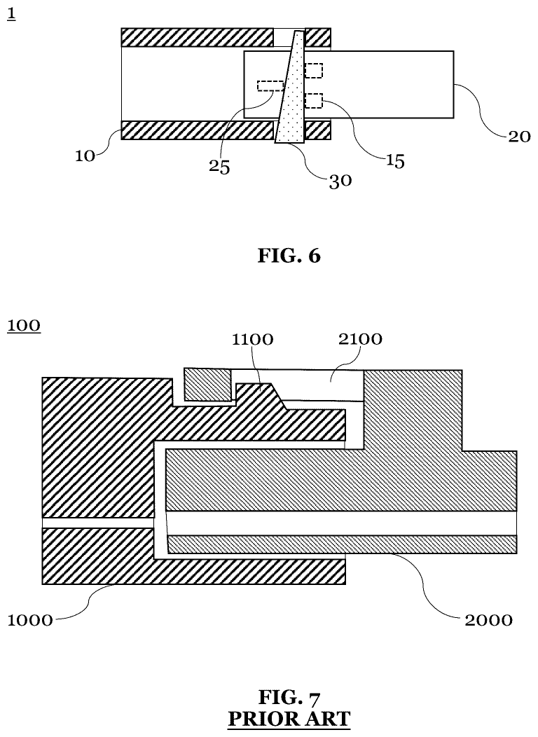

FIG. 4, FIG. 5, and FIG. 6 show a connector system 1 according to a second example. The connector system 1 includes a first connector housing 10 having a first locking feature 11. Further, the connector system 1 includes a second connector housing 20 being configured to mate with the first connector housing 10 and having a second locking feature 21. Moreover, the connector system 1 includes a CPA element 30 being configured to tension the first locking feature 11 and the second locking feature 21 relative to each other when the CPA element 30 is assembled with the mated connector housings 10, 20. Other than in the first embodiment, the first and second locking feature 11, 21 are configured to indirectly lock the first connector housing 10 and the second connector housing 20 with each other by feature of the CPA element. However, similarly to the first embodiment, the CPA element 30 has a tapered wedge shape and can be assembled with the first and the second connector housing 10, 20 only when they are mated with each other.

Furthermore, as also depicted in FIG. 4, FIG. 5, and FIG. 6, the first locking feature 11 includes a first abutment portion 15 adapted to abut the CPA element 30 and the second locking feature 21 includes a second abutment portion 25 to abut the CPA element 30. Thereby the CPA element 30 is adapted to press the first abutment portion 15 and the second abutment portion 25 away from each other when being assembled with the mated connector housings 10, 20. Particularly, the CPA element 30 is insertable between the first abutment portion 15 and the second abutment portion 25 along a direction which substantially extends perpendicular to the mating direction of the first and second connector housings 10, 20. Said first abutment portion 15 includes a protrusion and said second abutment portion 25 also includes a protrusion. The first abutment portion 15 is arranged on an inner circumferential surface of the first connector housing 10 and the second abutment portion 25 is arranged on an outer circumferential surface of the second connector housing 20.

It is understood that in any of the first and/or second connector system 1 a first electrical contacting feature may be arranged within the first connector housing 10 and a second electrical contacting feature arranged within the second connector housing 20. Said first and second electrical contacting feature may be adapted to establish electrical contact when the first connector housing 10 is mated with the second connector housing 20.

Moreover, even though neither implemented in the first embodiment nor the second embodiment, it is understood that the first connector housing 10 and/or the second connector housing 20 may include an actuation surface being arranged to slidingly guide the CPA element 30 into the assembled position when the connector housings are mated, wherein the actuation surface is inclined relative to the direction along which the CPA element 30 is insertable into the first connector housing 10 and/or the second connector housing 20.

Furthermore, it is understood that combinations of the first embodiment, which is depicted in FIG. 1, FIG. 2, and FIG. 3, with the second embodiment, which is depicted in FIG. 4, FIG. 5, and FIG. 6, are conceivable.

While this invention has been described in terms of the preferred embodiments thereof, it is not intended to be so limited, but rather only to the extent assembly forth in the claims that follow. For example, the above-described embodiments (and/or aspects thereof) may be used in combination with each other. In addition, many modifications may be made to configure a particular situation or material to the teachings of the invention without departing from its scope. Dimensions, types of materials, orientations of the various components, and the number and positions of the various components described herein are intended to define parameters of certain embodiments and are by no feature limiting and are merely prototypical embodiments.

Many other embodiments and modifications within the spirit and scope of the claims will be apparent to those of skill in the art upon reviewing the above description. The scope of the invention should, therefore, be determined with reference to the following claims, along with the full scope of equivalents to which such claims are entitled.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses all possible combinations of one or more of the associated listed items. It will be further understood that the terms “includes,” “including,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context. Additionally, while terms of ordinance or orientation may be used herein these elements should not be limited by these terms. All terms of ordinance or orientation, unless stated otherwise, are used for purposes distinguishing one element from another, and do not denote any order of arrangement, order of operations, direction or orientation unless stated otherwise.

1. A connector system, particularly an electrical connector system, comprising:
a first connector housing having a first locking feature;
a second connector housing being configured to mate with the first connector housing and having a second locking feature, wherein the first and second locking feature are configured to lock the first connector housing and the second connector housing with each other, and
a connector position assurance (CPA) element configured to tension the first locking feature and the second locking feature relative to each other when the CPA element is assembled with the mated connector housings.

2. The connector system according to claim 1, wherein the CPA element has a tapered shape.

3. The connector system according to claim 2, wherein the CPA element has a wedge shape.

4. The connector system according to claim 1, wherein the first connector housing comprises an actuation surface being arranged to slidingly guide the CPA element into the assembled position when the connector housings are mated.

5. The connector system according to claim 4, wherein the actuation surface is inclined relative to a direction along which the CPA element is insertable into the first connector housing.

6. The connector system according to claim 1, wherein the second connector housing comprises an actuation surface being arranged to slidingly guide the CPA element into the assembled position when the connector housings are mated.

7. The connector system according to claim 6, wherein the actuation surface is inclined relative to a direction along which the CPA element is insertable into the second connector housing.

8. The connector system according to claim 1, wherein the connector system is configured such that the CPA element can be assembled with the first and the second connector housing only when they are mated with each other.

9. The connector system according to claim 1, wherein the first locking feature comprises a locking receiving area and the second locking feature comprises a resilient arm with a locking portion shaped to form-fittingly engage with the locking receiving area.

10. The connector system according to claim 9, wherein the CPA element is adapted to press the locking portion into the locking receiving area when the CPA element is assembled with the mated connector housings.

11. The connector system according to claim 10, wherein the locking receiving area comprises a ramp surface being arranged such that the locking portion is urged into a clearance-free position when the CPA element presses the locking portion towards the locking receiving area.

12. The connector system according to claim 11, wherein the locking receiving area has a tapered shape.

13. The connector system according to claim 12, wherein the locking receiving area tapers in a direction along which the locking portion is engageable with the locking receiving area.

14. The connector system according to claim 9, wherein the locking receiving area is arranged on an outer circumferential surface of the first connector housing.

15. The connector system according to claim 1, wherein the first locking feature comprises a first abutment portion adapted to abut the CPA element and the second locking feature comprises a second abutment portion to abut the CPA element.

16. The connector system according to claim 15, wherein the CPA element is adapted to press the first abutment portion and the second abutment portion away from each other when being assembled with the mated connector housings.

17. The connector system according to claim 15, wherein the CPA element is insertable between the first abutment portion and the second abutment portion along a direction which substantially extends perpendicular to a mating direction of the first and second connector housings.

18. The connector system according to claim 15, wherein the first abutment portion comprises a first protrusion and the second abutment portion comprises a second protrusion.

19. The connector system according to claim 15, wherein the first abutment portion is arranged on an inner circumferential surface of the first connector housing and wherein the second abutment portion is arranged on an outer circumferential surface of the second connector housing.

20. The connector system according to claim 1, wherein the connector system comprises a first electrical contacting feature arranged within the first connector housing and a second electrical contacting feature arranged within the second connector housing, wherein the first and second electrical contacting feature are adapted to establish electrical contact when the first connector housing is mated with the second connector housing.
